(19) United States
(12) Patent Application Publication
(10) Pub. No.: US 2010/0104398 A1
(43) Pub. Date: Apr. 29, 2010

(54) FASTENER FOR BATHING APPARATUS

(76) Inventors: Guy LEMIRE, Beaumont (CA); Michael Lloyd AITKEN, Bremen, IN (US); Steve DONNELLY, Saint-Antoine de Tilly (CA); Patrice GENOIS, Neuville (CA)

Correspondence Address: PORZIO, BROMBERG & NEWMAN, P.C.;Suite 201, 29 Thanet Road, Princeton, NJ, 08540, US

(21) Appl. No.: 12/565,222

(22) Filed: Sep. 23, 2009

Related U.S. Application Data
(60) Provisional application No. 61/099,404, filed on Sep. 23, 2008.

(51) Int. Cl. F16B 19/00; B23P 17/04

(52) U.S. Cl. 411/510; 29/525.01

(57) ABSTRACT

The present invention concerns a novel fastener that will find many applications. The fastener generally includes two sections, a head section and a pin section. The pin section consists of a generally elongate shaft that is divided into a barbed section including one or more distinctive barbs and a smooth section. As described herein, the features of this fastener greatly facilitate the assembly of components of pre-fabricated bathing apparatus, such as showers and bathtubs. Advantageously, the fastener may be manufactured from plastic or any other synthetic polymer, and can therefore be lightweight and economical to produce.

### CROSS REFERENCE TO RELATED APPLICATION

This application claims priority on U.S. Provisional Patent Application Ser. No. 61/099,404 filed Sep. 23, 2008, the entirety of which is hereby incorporated by reference into this application.

### BACKGROUND OF THE INVENTION

### FIELD OF THE INVENTION

The present invention relates a novel fastener. More specifically, the invention concerns a novel fastener that will find many applications, including the assembly of components of pre-fabricated bathing apparatus such as showers and bathtubs.

Pre-fabricated bathing apparatus, such as showers and bathtubs, are frequently manufactured in components that are to be assembled on site. For reasons of transportation, size and installation, this is often necessary. Ideally, once on site, the assembly process should be easy and fast to minimize costs.

Generally, a modern bathing apparatus comprises a base unit and wall units that must be attached to one another as well as to the structure of the building in which it is housed. This attachment must be done in a way that will prevent water leakage and that will not cause the building to deteriorate.

Canadian Patent No. 1,276,404 (Herb et al.) shows how the components of a sectional bathing enclosure may be assembled through the use of “guide” pins. These guide pins allow on-site assembly in a fairly easy manner, but their positioning in the bathing enclosure is such that there is a necessity for the utilization of separate sealing means to ensure that the enclosure is waterproof.

U.S. Pat. No. 5,778,463 (Techchandani et al.) describes the installation of a multi-piece tub or shower having a trackless shower door. The back wall and side walls are interconnected at the point of assembly by a “Christmas tree clip” that is characterized by having two ribbed shanks separated by a shank head. Caulking is then placed along the points of assembly.

Despite the existence of the aforementioned pins or clips, there remains a need for a fastener that is inexpensive to manufacture and that may be tailored for use with different bathing apparatus.

The present invention seeks to address these and related needs.

### SUMMARY OF THE INVENTION

The present invention provides a novel fastener that facilitates the assembly of pre-fabricated components, such as those found in modern day showers and bathtubs. This fastener is sturdy and watertight, as required for use in applications such as the assembly of pre-fabricated bathing components found in modern day shower and bathtub installations.

As will be described in further detail below, the fastener comprises two general sections, a head section and a pin section. The pin section consists of a generally elongate shaft that is divided into a barbed section, which includes one or more distinctive barbs, and a smooth section.

Advantageously, the fastener may be produced from plastic or any other synthetic polymer, offering a lightweight and economical alternative to the fasteners that are currently in use. The fastener is also easy to use and install. When utilized to assemble a bathing apparatus, for example, the intervention of a plumbing professional is not necessarily required. In addition, the inclusion of one or more fasteners in an assembly does not interfere with the application of sealant between parts.

Other objects, advantages and features of the present invention will become apparent upon reading of the following non-restrictive description of embodiments thereof, given by way of example only with reference to the accompanying drawings.

### BRIEF DESCRIPTION OF THE DRAWINGS

FIG. 1 shows a representative embodiment of the fastener of the present invention, with (A) illustrating a perspective view, (B) a side view and (C) a cross-sectional view of the fastener.

FIG. 2 illustrates the use of the fastener of FIG. 1 in the assembly of a shower stall. In (A), the fastener is inserted through a section of the base of the shower stall, while in (B) and (C), the fastener is inserted through both a section of the base and a section of the wall of the shower stall.

### DETAILED DESCRIPTION OF THE INVENTION

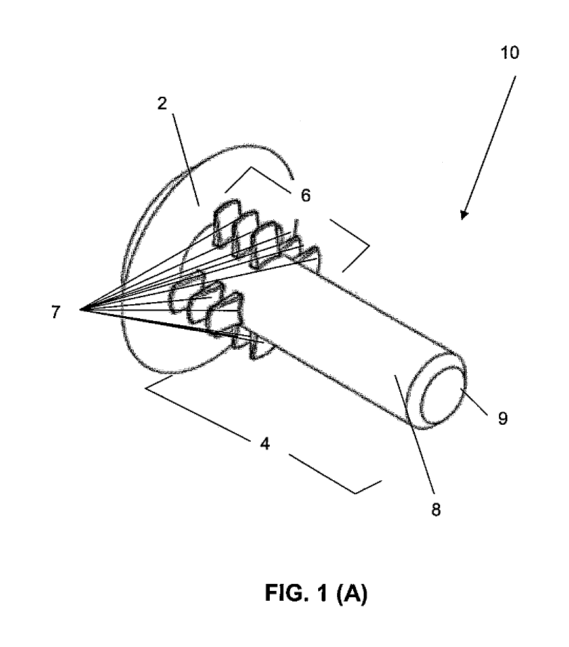

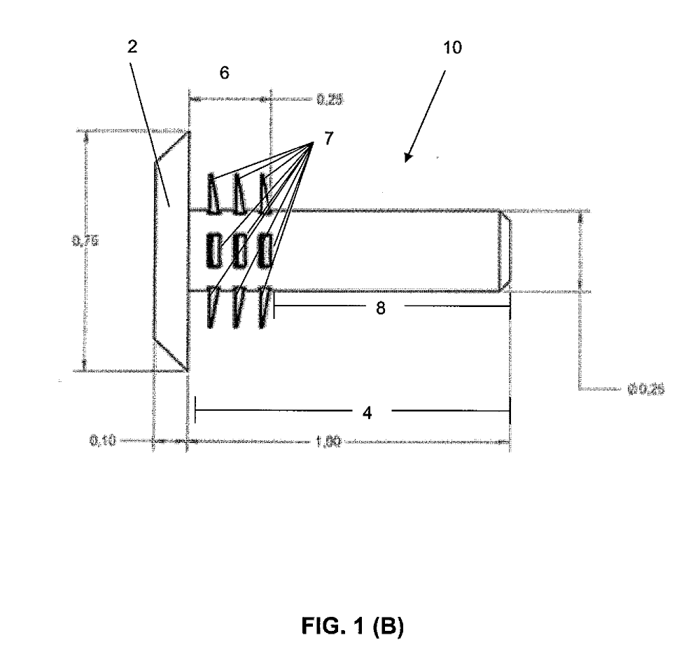

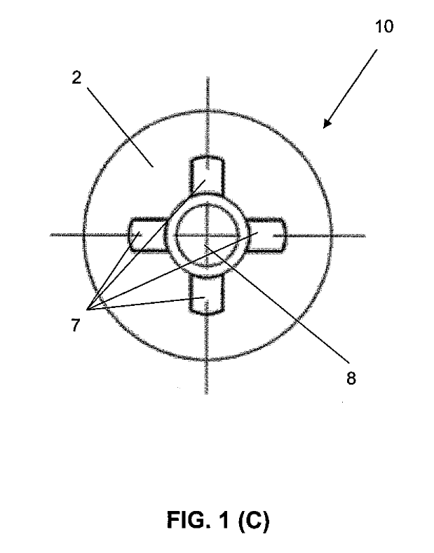

As used herein, the term “barb” means a protuberance, projection or the like extending from the generally elongate shaft portion of the fastener. As may seen in FIG. 1, the barbs are represented here as short, rectangular elements with rounded edges, but they can assume an infinite variety of shapes and dimensions.

FIG. 1 shows a representative embodiment of the fastener of the present invention, wherein the fastener is generally designated by the numeral 10. The fastener 10 comprises two general sections: a head section 2 and a pin section 4.

As shown in FIG. 1, the head section 2 of the fastener is generally circular and convex when viewed directly (or concave when viewed from the end of the pin section 4), but it can be assume other shapes. It may be beveled, as also shown in FIG. 1, or it may be pointed, rounded or assume any other configuration or geometry that is suitable for its intended purpose.

With reference once again to FIG. 1, the pin section 4 includes a generally elongate shaft portion that is divided into a barbed section 6 comprising one or more distinctive barbs 7, and smooth section 8. The length and thickness of the barbed section 6 is configured in relation to the length and thickness of the first portion of the assembly into which the fastener 10 is to be inserted. The length and thickness of the smooth 8 section may be varied and it may assume a variety of shapes to facilitate its insertion into another part of an assembly (i.e., it may be generally cylindrical in shape or a cyclic polygon of some kind). The tip 9 of the smooth section 8 may be beveled, as shown in FIG. 1, pointed, rounded or assume any configuration or geometry that is required for the desired use of the fastener.

Typically, the various components of the bathing apparatus are manufactured in a plant and then positioned relative to one another in the exact same way and location as the installer would be called to do on site. Holes are drilled in the surfaces of different parts that are either connected to each other or ultimately face one another. Some holes will be used to insert fasteners to hold parts together during transportation. Other holes will be used for the insertion of the fastener 10. The orientation and location of the fastener 10 is determined by the assembly order of the parts on construction site.

Once the entire bathing assembly is at its destination, the installer removes the fasteners holding the parts together during transportation. The disassembly has the purpose of reducing the weight and size of assembly to facilitate the installation. Advantageously, usually only one installer is required to do the job.

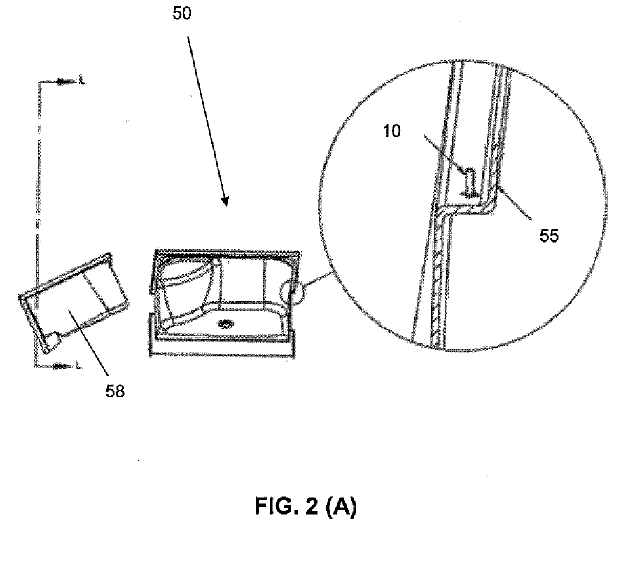

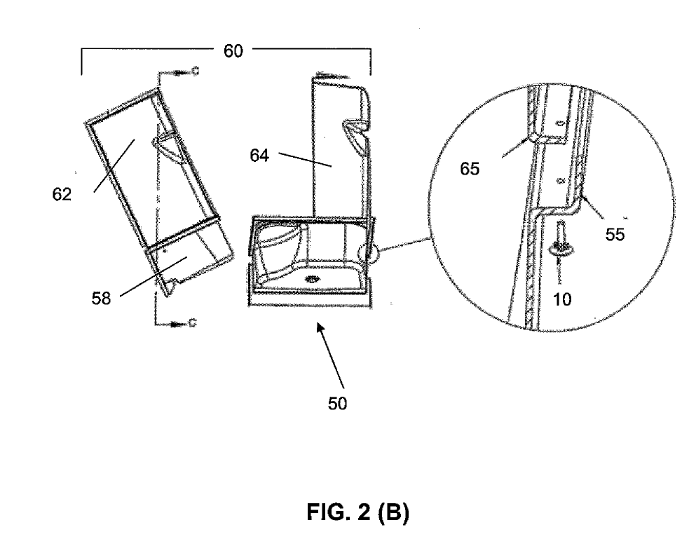

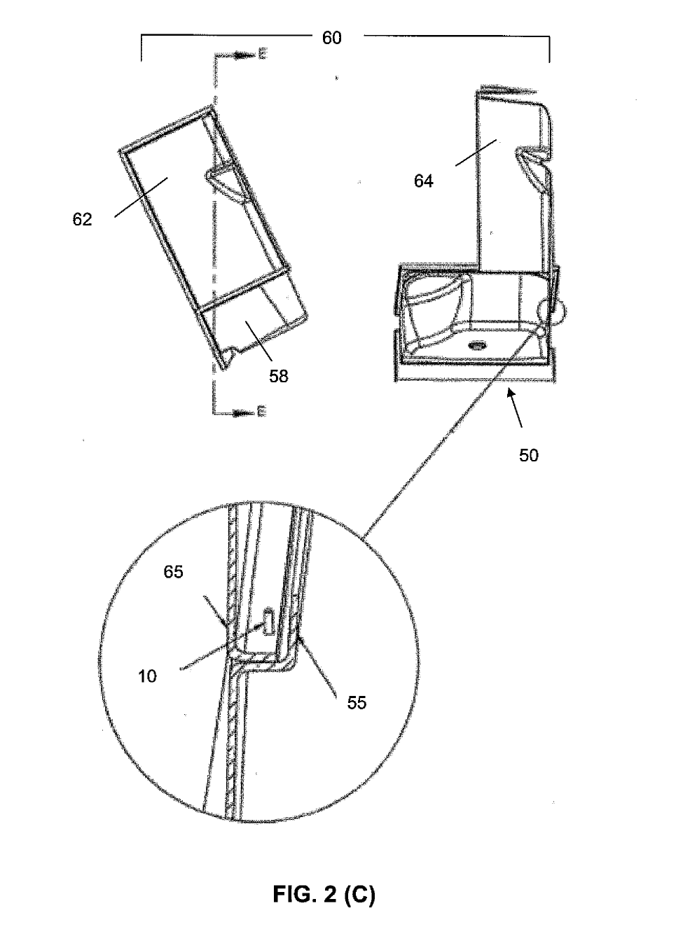

FIG. 2 shows how a bathing apparatus may be assembled using the fastener. Here, a shower base 50 is connected either to a base unit 58 that serves to complete it (FIG. 2 (A)), or to a shower wall 60 that includes two panels 62 and 64, each of which includes a base unit 58 (FIG. 2 (B) and (C)). First, the base 50 is brought in place, aligned and fixed to the floor and wall structure with fasteners, such as screws or nails. One or more fasteners 10 are inserted in a flange 55 of the shower base 50 in a manner that enables the reception of a second component of the shower assembly. The second component of the assembly is fixed to the building structure with fasteners, such as screws or nails. The second component is also designed to include fasteners 10, and these fasteners 10 are oriented in a manner that allows the reception of another component of the assembly. As illustrated in FIG. 2 (B) and (C), a fastener 10 is introduced in the flange 55 of the shower base 50. Then, a corresponding flange 65 of the shower wall panel 64 is placed over the smooth section 8 of the fastener 10, completing the assembly of these particular components. The magnified views in FIG. 2 (A), (B) and (C) reveal the details of the fastener in the final assembly.

The process continues until the entire assembly is complete. The use of barbed fasteners 10 does not interfere with the application of sealant between parts. Sealants may be used following the installation of the components of the assembly to complete the shower stall.

Advantageously, the fastener 10 may be manufactured using plastic or other synthetic polymers, as generally known in the art. This provides a lightweight and economical alternative to the fasteners that are currently in use for the installation of bathing apparatus, without compromising on sturdiness or water or air tightness. Alternatively, the fastener 10 may be produced using metals or alloys (i.e., either iron or non-iron containing alloy), including without limitation aluminum, iron and stainless steel, once again in keeping with practices known in the art. In addition, the head section of the fastener may be overmolded using a different synthetic polymer in order to create a more flexible, watertight portion area within the head section.

### EXAMPLE 1

Fasteners will typically range from approximately ¼ to ⅜ inch in diameter and ¾ to 1½ inch in length. A sample fastener has been manufactured from nylon and includes the following features and dimensions:
A head section that is beveled and has a diameter of approximately ¾ inch at its widest end. The width of the head section is approximately 1/10 inch.
A pin section that measures approximately 1 inch and has a diameter of approximately ¼ inch. The pin section includes a distinctive barbed section and a smooth section.

The overall length of the barbed section is approximately ¼ inch and includes a total of 12 barbs that are organized in 4 groups of 3 consecutive but non-contiguous barbs, each group being an equal distance from its immediately neighbor. The barbs may also be organized in other convenient patterns, such as, for example, in three groups equidistantly apart (i.e., to form a triangular shape).
The overall length of the smooth section is ¾ to 1½ inch, depending on the diameter of the pin. The tip of the smooth section is beveled.

While the present fastener has been described in relation to its specific use in the assembly of pre-fabricated bathing apparatus, it will be appreciated that it may also be used in other applications requiring the connection of components.

The above-described embodiments of the invention are intended to be examples only. Variations, alterations and modifications can be made to the particular embodiments described herein by those of skill in the art without departing from the scope of the invention, as defined in the appended claims.

What is claimed is:

1. A fastener comprising a head section and a pin section, wherein said pin section comprises a generally elongate shaft that is divided into a barbed section that includes one or more barbs and a smooth section.

2. The fastener as defined in claim 1, wherein the head section is generally circular and convex when viewed directly.

3. The fastener as defined in claim 1, wherein the tip of the smooth section is generally circular and concave relative to the head section.

4. The fastener as defined in claim 1, wherein the tip of the smooth section is beveled.

5. The fastener as defined in claim 1, wherein the smooth section is generally cylindrical.

6. The fastener as defined in claim 1, wherein the smooth section is a cyclic polygon.

7. The fastener as defined in claim 1, wherein the barbs are rectangular in shape and have rounded edges.

8. The fastener as defined in claim 1, wherein the length and thickness of the barbed section is configured in relation to the length and thickness of the first portion of the assembly into which said fastener is to be inserted.

9. The fastener as defined in claim 1, which is made of plastic or a synthetic polymer.

10. A method of assembling an apparatus comprising the step of:
joining two or more components of the apparatus together using the fastener as defined in claim 1.

11. A method of transporting components of an apparatus comprising the step of:
joining two or more components of the apparatus together during transportation using the fastener as defined in claim 1.

12. The method as defined in claim 10, wherein said apparatus is a bathing apparatus.

13. The method as defined in claim 12, wherein said bathing apparatus is a bath or shower.
